(19) United States
(12) Patent Application Publication
(10) Pub. No.: US 2020/0029584 A1
(43) Pub. Date: Jan. 30, 2020

(54) SMOKER BOX

(71) Applicant: Barry Lee Rohweder, St. Louis Park, MN (US)

(72) Inventor: Barry Lee Rohweder, St. Louis Park, MN (US)

(21) Appl. No.: 16/048,448

(22) Filed: Jul. 30, 2018

(51) Int. Cl. A23B 4/052

(52) U.S. Cl. CPC A23B 4/0523; A23V 2002/00

(57) ABSTRACT

A smoker box for use in a gas grill provides improved thermal distribution with a construction of:

a fire resistant, heat-conductive housing having a base, a gas flow volume for smoke-generating combustible material and a chimney with a controlled-emission opening, wherein:
a) the base having a perimeter that establishes a support for the gas flow volume;
b) side walls extend inwardly from the perimeter towards a central area of the smoker box to form side enclosure faces for the gas flow volume;
c) the side walls extend to a vertical chimney structure having a smoke-generating combustible material over the gas flow volume; and
d) the vertical chimney structure has an adjustable cap above the vertical chimney element storage volume for smoke-generating combustible material which adjusts smoke flow out of the storage volume.

### FIELD OF THE INVENTION

The present invention relates to smoker attachments. More specifically, the present invention provides a smoker attachment for a gas grill that enables individuals to convert a conventional gas grill into a smoker.

### BACKGROUND OF THE INVENTION

One popular way of preparing meats and other foods is to apply heat and smoke to the food for a continuous period. This process, referred to as “smoking,” uses low heat to cook the food while the smoke imparts a desirable flavor. Food is typically smoked in a dedicated smoker device. However, these devices can be prohibitively expensive and difficult to assemble and use.

While few people have a dedicated smoker, many have a gas grill to prepare foods. Some attempt to impart a smoky flavor to the food by placing an open container of a smoke source such as wood chips onto the cooking surface of the grill. While this can impart the food with a smoky taste, the container takes up valuable space on the grill's cooking surface and uncontrolled burning can occur within the grill. Further, the heat imparted to the wood chips can reduce the heat provided to the food, slowing or impairing the cooking process. In light of the above concerns, there is need in the art for a smoker attachment for a gas grill that attaches to the exterior of a gas grill and directs smoke into the interior cooking area of the grill, imparting a smoky flavor to foods prepared therein.

Devices have been disclosed in the known art that relate to smoker attachments. These include devices that have been patented and published in patent application publications. However, the devices in the known art have several drawbacks. These devices are typically secured within the interior of the gas grill cooking area, which takes up cooking space. Additionally, these devices tend to be costly because they include complicated construction including various baffles and channels to direct the smoke. Other designs alter heat flow patterns below the meat or food to be smoked, causing difficulties in even cooking of materials over different areas of the grill.

### SUMMARY OF THE INVENTION

A smoker box for use in a gas grill provides improved thermal distribution with a construction of:
a fire resistant, heat-conductive housing having a base, a gas flow volume for smoke-generating combustible material and a chimney with a controlled-emission opening, wherein:
a) the base having a perimeter that establishes a support for the gas flow volume;
b) side walls extend inwardly from the perimeter towards a central area of the smoker box to form side enclosure faces for the gas flow volume;
c) the side walls extend to a vertical chimney structure having a smoke-generating combustible material over the gas flow volume; and
d) the vertical chimney structure has an adjustable cap above the vertical chimney element storage volume for smoke-generating combustible material which adjusts smoke flow out of the storage volume.

### BRIEF DESCRIPTION OF THE FIGURES

FIG. 1 shows a perspective view of a smoke box of the present invention (without an adjustable cap).

FIG. 1A shows a top view of one embodiment of an adjustable cap over a vertical chimney structure.

FIG. 2 shows a side view of a smoke box of the present invention with smoke generating material within its volume.

FIG. 3 shows a side view of air flow around the sides of a smoke box of the present invention.

FIG. 3A shows a side view of air flow around the sides of a smoke box of the prior art.

### DETAILED DESCRIPTION OF THE INVENTION

A smoker box for use in a gas grill improves heat flow patterns within the grill with a structure including:

a fire resistant, heat-conductive housing having a base or bottom edge, a heated gas flow volume for combustible material and a chimney having a storage volume for retaining smoke-emitting mass or materials, the chimney also having a controlled-emission opening, wherein:
a) the base having a perimeter that establishes a support edge or layer for the heated gas flow volume;
b) side walls extend inwardly from the perimeter towards a central area of the smoker box to form side enclosure faces for the heated gas flow volume;
c) the side walls extend to a vertical chimney structure over the heated gas flow volume; and
d) the vertical chimney structure has an adjustable cap above the storage volume which adjusts gas flow out of the storage volume through the vertical chimney structure.

The smoker box may have the housing formed of metal, metal alloys, composites and other fire-resistant, heat-conductive components. In particular, the base, side walls and vertical chimney structure should be fire-resistant, heat-conductive metal such as steel, brass, copper, bronze, iron, stainless steel, titanium, aluminum and the like. The adjustable cap is also preferably a fire-resistant, heat-conductive material as above and especially metal. Where the base perimeter is relatively square or rectangular, the side walls form a truncated pyramidal shape with the base perimeter. The vertical chimney structure may include a circular, oval, square or rectangular tube extending upwards from the side walls. Where the base perimeter is relatively oval or round, and the side walls form a truncated conical shape with the base. The vertical chimney structure comprises a circular, square or rectangular tube extending upwards from the side walls.

The smoker box may have the adjustable cap fixed to a point or edge on a perimeter of a top of the vertical chimney structure and as the adjustable cap pivots about the point or edge, more or less of a cross-section of the vertical chimney structure is exposed, increasing or decreasing flow through the vertical chimney structure, respectively.

Alternatively, the smoker box may have the adjustable cap slide along a guide path across a cross-section of the vertical chimney structure so that more or less of the cross-section of the vertical chimney structure is exposed, increasing or decreasing flow through the vertical chimney structure, respectively.

The smoker box may have a profile from a vertical perspective (looking down onto the top of the smoker box) of the smoker box displays a cross-section area for the side walls which is at least four, at least six or even at least eight times greater than the cross-section of the vertical chimney structure. It is this perspective ratio of areas that contributes to the control of heat flow patterns within the grill.

Heat flow from many of the box structures (literal a box-shape or inverted pyramidal shape) have heat currents that flow vertically around the edges of the smoke boxes and cause vortexes, tending to direct heat so that significant heat is lost around the center of the box. By having a more vertically oriented pyramidal (truncated) and conical (truncated) shape, the vortexes are drawn more to the center, moderating (but not perfecting) upward heat flow around the present inventive smoker box. This, in combination with the more easily controlled flow of smoke from the storage volume (where the smoke-creating material is being is heated or burned), creates more even distribution and control of both the heat of the grill and the smoking activity from the smoke-creating material.

Looking at the figures will assist in a further understanding of the invention.

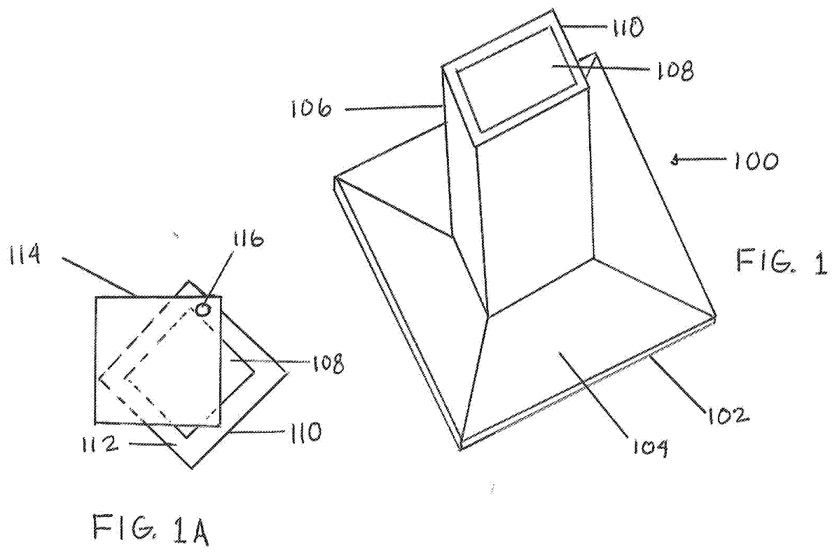

FIG. 1 shows a perspective view of a smoke box 100 of the present invention (without an adjustable cap) having a base perimeter 102, side walls 104, a vertical chimney structure 110, a lumen or passageway 108 within the vertical chimney structure 106 and an edge 106 leading to the top of the vertical chimney structure 110. The base perimeter may be exclusively bottom edges of the side walls 104 or may be a plate forming the base perimeter 102 with at least 20% of the plate being open (e.g., with holes or the plate having a continuous open area within the plate) or at least 50% or 100% of the base plate (essentially being only the bottom edges of the side walls 104) being open.

FIG. 1A shows a top view of one embodiment of an adjustable cap 114 over a vertical chimney structure 110. The adjustable cap 114 pivots on a pin 116 passing through the adjustable cap 114 and into a top ledge 112 in the vertical chimney structure 110. The passageway 108 is shown where smoke exits the vertical chimney structure 110 into the grill (not shown). In this figure, only a portion of the passageway 108 is exposed, to lightly smoke any product.

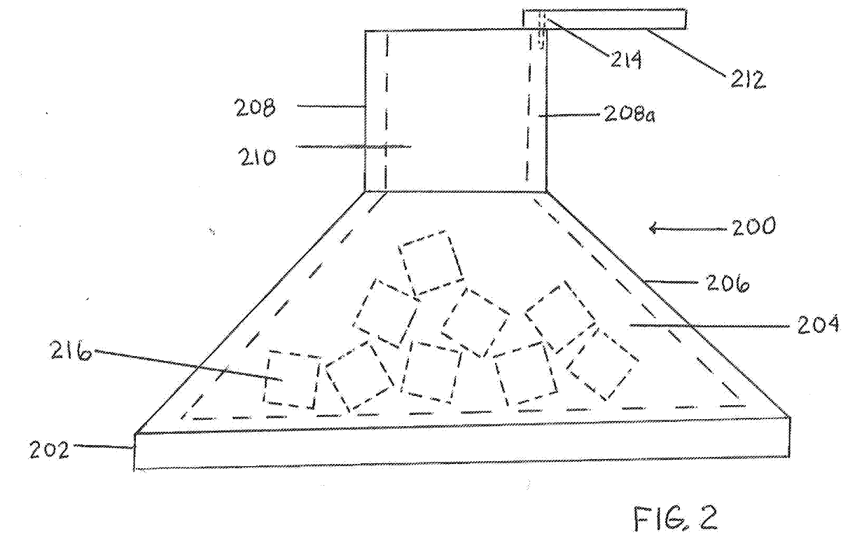

FIG. 2 shows a side view of a smoke box 200 of the present invention with smoke generating material 216 within the storage volume 210 within the chimney structure 208. The base perimeter 202 (which is defined by bottom edges of the side walls 206) and side walls 206 and vertical chimney structure 208 are shown. The adjustable cap 212 is shown pivoted open around pin 214 passing through the adjustable cap 212 and the thickness 208a of the vertical chimney structure 208. The passageway 210 is therefore completely open. One thing to note from this side view that the shapes of the base, side walls and chimney may be oval, round, is square or rectangular within FIG. 2. Also shown in FIG. 2 are preferred openings 209 in the side walls 206. These openings 209 are preferably less that 25% of the surface area of the side walls 206. These openings 209 allow heat from within the gas flow volume 204 to pass along the sides of the vertical chimney structure 208. The gas flow volume 204 allows heat from the grill (not shown) to flow upwardly to impact a lower surface of the vertical chimney structure 208 causing the smoke generating material (e.g., wood chips, wood pellets, compressed wood competition etc.) 216 to oxidize and release smoke into the cooking volume of a gas grill (not shown). Heated gas will continuously flow out of the gas flow volume 204 through the openings 209. Element 218 is a solid heat resistant plate (again most likely a metal or alloy) or a metal plate with pores small enough to prevent the smoke generating material 216 from dropping through the plate 218.

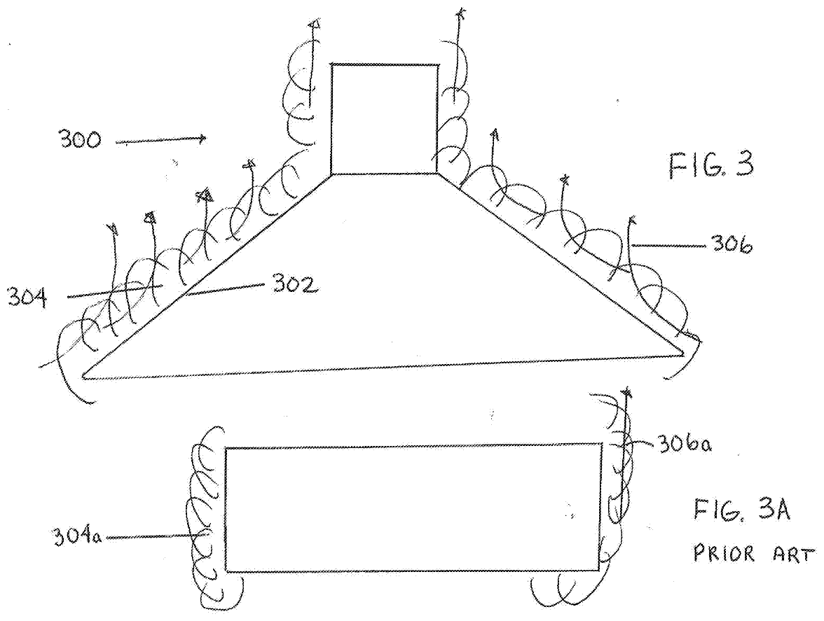

FIG. 3 shows a side view of air flow 318 into the volume within the side walls 302 as a vertical air flow 318 that is directed as angled air flow 320 after striking the inside surface of the side wall 302, heating the smoke generating material 316 within the storage volume 314 within the vertical chimney element 312 and vertical heated air movement 306 around the side walls 302 of a smoke box 300 of the present invention. Heated containing gas flow 306a comes out of the openings 310 in the side walls 302. Heated smoke-containing gases 308 flow upwardly out of the vertical chimney structure 312 after smoke generating material 316 is being oxidized within the vertical chimney structure 312.

FIG. 3 shows a side view of air flow 304 as a vortex and vertical movement 306 around the sides 302 of a smoke box 300 of the present invention. Because of the sloped walls and the flow through design, the heat chimney concentrates the heat on the bottom and sides of the smoking chamber.

FIG. 3A shows a side view of vortex 304a and vertical 306a air flow around the sides of a virtual smoke box of the prior art.

Wood chips or pellets can be in the chimney/smoke chamber (the volume above the base) but the chimney may have a solid bottom or solid with pores to allow air flow through the base. The heat funnel (truncated pyramidal base) and the smoker chimney are separated by solid metal as the side walls. The holes passageway in the top of the heat funnel allow for the heat to pass along sides of the chimney (smoke chamber) thus heating the walls and bottom of the smoke chimney/chamber. If there were no holes in the top of the heat funnel, the bottom of the smoker box would create an air current around the unit, this allows the heat to pass through and along the heating metal. The holes also allow for uniform burning of the grill gas. Gas grill burners are designed to have uniform vertical air flow, a typical smoker box has a solid bottom. The “Smokin Genie”™ smoker is designed to sit on either the same grate as lava rocks (heat dispersing aggregate) or on the cooking surface grates. In the first instance, one would use a utensil to reach through the cooking surface grates to adjust the lid of the smoke chamber.

What is claimed:

1) A smoker box for use in a gas grill comprising:
a fire resistant, heat-conductive housing having a base, aa gas flow volume below a storage volume for combustible material within a chimney with a controlled-emission opening, wherein:
a) the base having a perimeter that establishes a support layer or edge for the storage volume;
b) side walls extend inwardly from the perimeter towards a central area of the smoker box to form side enclosure faces for the gas flow volume;
c) the side walls extending to a vertical chimney structure over the storage volume; and
d) the vertical chimney structure has an adjustable cap above the storage volume which adjusts gas flow out of the storage volume through the vertical chimney structure.

2) The smoker box of claim 1 wherein the housing comprises metal components.

3) The smoker box of claim 2 wherein the base, side walls and vertical chimney structure comprise fire-resistant, heat-conductive metal.

4) The smoker box of claim 3 wherein the adjustable cap comprises fire-resistant, heat-conductive metal.

5) The smoker box of claim 3 wherein the base is relatively square or rectangular, and the side walls form a truncated pyramidal shape with the base and the side walls have an opening therein to allow heated gas flow from below the side walls.

6) The smoker box of claim 5 wherein the vertical chimney structure comprises a circular, square or rectangular tube extending upwards from the side walls.

7) The smoker box of claim 3 wherein the base is relatively oval or round, and the side walls form a truncated conical shape with the base and the side walls have an opening therein to allow heated gas flow from below the side walls.

8) The smoker box of claim 7 wherein the vertical chimney structure comprises a circular, square or rectangular tube extending upwards from the side walls.

9) The smoker box of claim 4 wherein the adjustable cap is fixed to a point on a perimeter of a top of the vertical chimney structure and as the adjustable cap pivots about the point, more or less of a cross-section of the vertical chimney structure is exposed, increasing or decreasing smoke is flow out of the vertical chimney structure, respectively.

10) The smoker box of claim 5 wherein the adjustable cap is fixed to a point on a perimeter of a top of the vertical chimney structure and as the adjustable cap pivots about the point, more or less of a cross-section of the vertical chimney structure is exposed, increasing or decreasing smoke flow out of the vertical chimney structure, respectively.

11) The smoker box of claim 6 wherein the adjustable cap is fixed to a point on a perimeter of a top of the vertical chimney structure and as the adjustable cap pivots about the point, more or less of a cross-section of the vertical chimney structure is exposed, increasing or decreasing smoke flow out of the vertical chimney structure, respectively.

12) The smoker box of claim 4 wherein the adjustable cap slides along a guide path across a cross-section of the vertical chimney structure so that more or less of the cross-section of the vertical chimney structure is exposed, increasing or decreasing flow through the vertical chimney structure, respectively.

13) The smoker box of claim 5 wherein the adjustable cap slides along a guide path across a cross-section of the vertical chimney structure so that more or less of the cross-section of the vertical chimney structure is exposed, increasing or decreasing smoke flow out of the vertical chimney structure, respectively.

14) The smoker box of claim 6 wherein the adjustable cap slides along a guide path across a cross-section of the vertical chimney structure so that more or less of the cross-section of the vertical chimney structure is exposed, increasing or decreasing smoke flow out of the vertical chimney structure, respectively.

15) The smoker box of claim 9 wherein a profile from a vertical perspective of the smoker box displays a cross-section area for the side walls which is at least four times greater than the cross-section of the vertical chimney structure.

16) The smoker box of claim 10 wherein a profile from a vertical perspective of the smoker box displays a cross-section area for the side walls which is at least four times greater than the cross-section of the vertical chimney structure.

17) The smoker box of claim 11 wherein a profile from a vertical perspective of the smoker box displays a cross-section area for the side walls which is at least four times greater than the cross-section of the vertical chimney structure.

18) The smoker box of claim 12 wherein a profile from a vertical perspective of the smoker box displays a cross-section area for the side walls which is at least four times greater than the cross-section of the vertical chimney structure.

19) The smoker box of claim 13 wherein a profile from a vertical perspective of the smoker box displays a cross-section area for the side walls which is at least four times greater than the cross-section of the vertical chimney structure.

20) The smoker box of claim 9 wherein a profile from a vertical perspective of the smoker box displays a cross-section area for the side walls which is at least six times greater than the cross-section of the vertical chimney structure.
